(19) United States
(12) Patent Application Publication
(10) Pub. No.: US 2004/0162582 A1
(43) Pub. Date: Aug. 19, 2004

(54) Treatment of osteoarthritis

(75) Inventor: Andreas Banziger, Rehetobel (CH)

Correspondence Address: HMTAG C/O STEFFEN STRAUSS, KREUZLIUGERSTR. 5, LEUGWIL, CH-8574, CH

(73) Assignee: HMT High Medical Technologies AG, Lengwil (CH)

(21) Appl. No.: 10/771,439

(22) Filed: Feb. 5, 2004

Related U.S. Application Data
(60) Provisional application No. 60/447,021, filed on Feb. 13, 2003.

(51) Int. Cl. A61H 5/00

(52) U.S. Cl. 607/1; 601/1

(57) ABSTRACT

This invention relates to a method for treating osteoarthritis in humans with acoustic pressure or shock waves. More particularly, the invention relates to a method for applying acoustic pressure or shock waves to normalize the increased molecular activities within the joint, reduce its inflammation, and thereby stop and/or reverse the osteoarthritic process.

### BACKGROUND OF THE INVENTION

1. Field of the Invention

This invention relates to a method for treating a osteoarthritis in humans with acoustic pressure or shock waves. More particularly, the invention relates to a method for using acoustic pressure or shock waves to normalize the increased molecular activities within the joint, especially on the level of the synovial tissue, reduce its inflammation, and thereby stop and/or reverse the osteoarthritic process.

2. Description of the Problem

Osteoarthritis is a degenerative joint disease which commonly affects both axial and peripheral diarthrodial joints in humans.

Joints are the intersections of two bones. The ends of the bones are covered with cartilage. Cartilage also acts as a cushioning device to absorb force applied to the joints. Synovial fluid carries nutrients to the cartilage, preventing it from becoming dry and brittle and keeping its surface lubricated so the joints can work smoothly. A structure called the joint capsule keeps the synovial fluid within the joint. The capsule encloses the joint and protects it.

Osteoarthritis is the deterioration of cartilage in the joints, resulting in pain and soreness. It produces little inflammation and the pain and soreness is caused by deterioration of cartilage in the joints. Osteoarthritis is the most common type of arthritis. A disease of cartilage, resulting from non inflammatory deterioration of the joint. It occurs with the normal process of aging.

Another cause is trauma, such as an injury to a joint. A patient who fractures an ankle bone is more likely to develop osteoarthritis in the ankle later. Overuse may also cause cartilage to break down.

3. Description of the Related Art

Osteoarthritis is difficult to treat. There is no cure and treatment focuses on relieving pain and preventing the affected joint from becoming deformed.

Nonsteroidal antiinflammatory drugs (NSAIDs) are used to relieve pain. As indicated by U.S. Pat. No. 4,997,850 and U.S. Pat. No. 4,944,949 many such nonsteroidal antiinflammatory drugs are known and are frequently effective in reducing the symptoms of osteoarthritis.

If these measures are unsuccessful, physicians may prescribe steroid injections to reduce swelling.

Physical therapy, orthotic shoe inserts such as described in U.S. Pat. No. 5,727,335 and custom-fitted braces also may also be recommended.

If the patient develops hallux rigidus, a condition in which the big toe (hallux) becomes painfully stiff or rigid, the podiatrist may recommend a larger, stiffer shoe with an inflexible sole. This limits the toe's movement and reduces weight bearing, particularly in walking, and prevents the surfaces of the toe joint from grinding painfully against each other.

In severe cases, joint replacement may be necessary. This is especially true in the hips and knees. Joints in the lower leg are smaller, more complex, and difficult to replace.

If a joint is extremely painful and cannot be replaced, it may be fused. This procedure stops the pain, but results in the permanent loss of joint function, making walking and bending difficult.

A method for the treatment of osteoarthritis, which comprises administering a therapeutically effective amount of cetyl myristoleate, is known from U.S. Pat. No. 5,569,676.

All pharmacological agents have a degree of complication associated with them. Surgery brings all the risks of anesthesia or sedation and the potential complications of any surgical procedure including sepsis and continued morbidity.

There are techniques for helping these patients as mentioned above but the expense of continual treatment in terms of medicines on the one hand and side effects as a result of these treatments on the other hand are proved harmful.

The present invention is related to a method for treating osteoarthritis in humans with acoustic pressure or shock waves.

### BRIEF SUMMARY OF THE INVENTION

In general, the present invention is directed to a method for treating osteoarthritis with acoustic pressure or shock waves in humans. More specifically, the present invention relates to a method for human medical treatment of osteoarthritis in humans with a sufficient number of acoustic pressure or shock waves. The novel method described herein uses acoustic pressure or shock waves to normalize the increased molecular activities within the joint, especially on the level of the synovial tissue, reduce its inflammation, and thereby stop and/or reverse the osteoarthritic process.

The current state of the art technology for producing extra corporeal shock waves in the most appropriate clinical manner is described below.

Shock waves are high energetic acoustic waves with high amplitude, characterized by extremely short build-up times. The shock waves are generated outside the body and can be focused at a specific site within the body.

The most common use of shock waves in humans is to break kidney and urethral stones into small fragments which can then be eliminated from the body. This is known as lithotripsy. In addition shock waves are now routinely used to treat common orthopedic problems in humans such as tennis elbow and non-healing fractures.

The method of treatment of the present invention includes applying a sufficient number of acoustic shock waves to the side of a abnormal condition to induce or accelerate healing. Applying the acoustic shock waves involves the deliberate introduction of a series of very high pressure, focused or non focused pulses into the area to be treated. The shock waves travel through fluid and soft tissue with their effects occurring at places where there is a change in the type of tissue. High forces of compression and tension are created as these acoustic shock waves meet a different type of tissue.

Applying the acoustic shock waves involves generating preferably about 500 to about 4000 acoustic shock waves. The acoustic shock waves may be applied either in a single treatment or in multiple treatments.

The application of shock waves to humans using a shock wave generator would be an effective treatment in degenerative joint disease which through normalizing the increased molecular activities within the joint, would prevent permanent inflammation and damage to the join and thereby stop and/or reverse the osteoarthritic process. Thereby reducing pain and permanent disability.

This novel method of application of shock waves reduces the number of additional treatments and produces therapeutic healing of these conditions with minimal risk of complications or damage. Generally speaking, it is hypothesized that shock waves triggers physiological repair mechanisms.

Furthermore, it has been observed to produce marked improvements in conditions which previously had no realistic hope of resolution, even with severe surgical measures with all the attendant risks. Surgery brings all the risk of anesthesia or sedation and the potential complication of any surgical procedure, including sepsis and continued morbidity.

The inventive method for treating osteoarthritis bears far less risk to the patient than pharmacological and surgical intervention.

### BRIEF DESCRIPTION OF THE DRAWING

These and other features, aspects and advantages of the present invention will become better understood with reference to the following description, appended claims, and accompanying drawing, where:

FIG. 1 is a schematic representation of a joint with degenerative joint disease,

FIG. 2 is a schematic representation of a shock wave generation device using the electro-hydraulic principle in accordance with the inventive method and

FIG. 3 is a schematic representation of a shockwave generator and positioning in accordance with the inventive method.

In the drawing, the principle of producing the shock waves is depicted only schematically. Equivalent parts are indicated by the same reference numbers.

List of Reference Numbers

2 bone

4 bone spurs

6 synovial fluid

8 cartilage fragments in fluid

10 shock wave generation device

12 electrode

14 focusing device

16 propagation of a high-pressure shock waves

18 focal peak pressure area

### DETAILED DESCRIPTION OF THE INVENTION

The invention summarized above and defined by the enumerated claims may be better understood by referring to the following detailed description, which should be read in conjunction with the accompanying drawing. This detailed description of a particular preferred embodiment, set out below to enable one to practice the invention, is not intended to limit the enumerated claims, but to serve as a particular example thereof.

The present invention is generally directed to treatment of osteoarthritis in humans with acoustic shock waves. In general, the objects and advantages of the present invention are achieved by applying a sufficient number of acoustic shock or pressure waves to a deterioration of cartilage in human joints.

Implementation of the method of the present invention requires the use of a shock or pressure wave source.

Currently there are three distinct methods of acoustic shock wave generation in medicine; the piezoelectric method, the electromagnetic method and the electro hydraulic method.

There is a further method of producing acoustic pressure waves used in medicine termed pneumatic or ballistic. This method revolves around the principle of accelerating a metal pellet to high velocity which transfers its energy to an applicator pin when it collides with it at the end of an enclosed cylinder. The energy transfer produces an acoustic pressure wave.

The preferential method of shock wave generation for the inventive method of the treatment of osteoarthritis in humans is the electro hydraulic method. But the novel invention is not limited to the electro hydraulic method of shock wave generation only.

The reason for utilizing the electro hydraulic method of shock wave generation is, that this method enables both the generation of high-pressure shock waves and of a large focal volume.

Specifically, for the electro hydraulic method the inventive method may include applying a range of approximately 14-28 kilovolts of energy pulse.

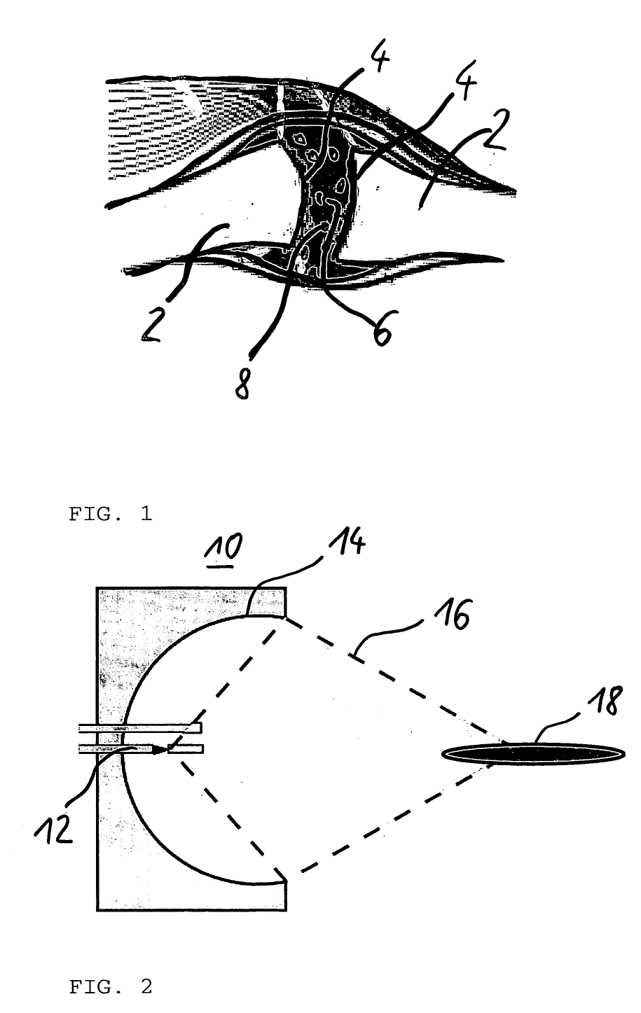

FIG. 1 illustrates a schematic of a joint with a degenerative joint disease. The ends of the bones 2, the bone spurs 4 are covered with cartilage. Cartilage is a smooth, durable substance that allows the bone spurs 4 to glide over each other with minimal friction. Synovial fluid 6, which is a viscous substance similar to oil, carries nutrients to the cartilage, preventing it from becoming dry and brittle and keeping its surface lubricated so the joint can work smoothly. A deterioration of the cartilage in the joint as a result of overuse or which occurs with the normal process of aging, produces little inflammation and small cartilage fragments 8 are separated in the synovial fluid 6. Pain and soreness is caused by osteoarthritis.

FIG. 2 illustrates a schematic of a shock wave generation device 10 with the electro hydraulic principle. Capacitors, not shown in the schematic, are charged with high voltage. The shock wave is generated by discharging the capacitors across the tips of an electrode 12 mounted in a focusing apparatus 14 preferably a fluid filled ellipsoid reflector. The subsequent, sudden vaporization of the water molecules between the tips of the electrode 12 causes the spherical propagation 16 of a high-pressure shock wave through the surrounding fluid. The method typically requires use of apparatus for focusing 14 the acoustic shock waves, such as an ellipsoid or parabolic reflector or focusing lens. The reflector 14 is generally located in the shock wave generation device 10, which directs the waves to a focal peak pressure area 18. Shock waves travel from electrode 12 through acoustic medium, which is not explicit shown in FIG. 2. Waves reflect from the ellipsoid surface of the reflector 14 and toward peak focal pressure area 18.

Due to the anatomical features of the human joint the shock-wave generation device 10 needed would have to be such that the shock waves could be introduced on the locating site or suspected site of an abnormal condition of osteoarthritis. In a preferred embodiment, the shock wave generation device 10 is designed as a hand-held shock wave generator. This is advantageous to deliver the shock waves to the humans joint in the appropriate fashion. In a further embodiment there are more than one hand-held shock wave generator devices 10 available. Each of the hand held shock-wave generator devices 10 is characterized by a specific depth, at which the focal peak pressure area 18 is located.

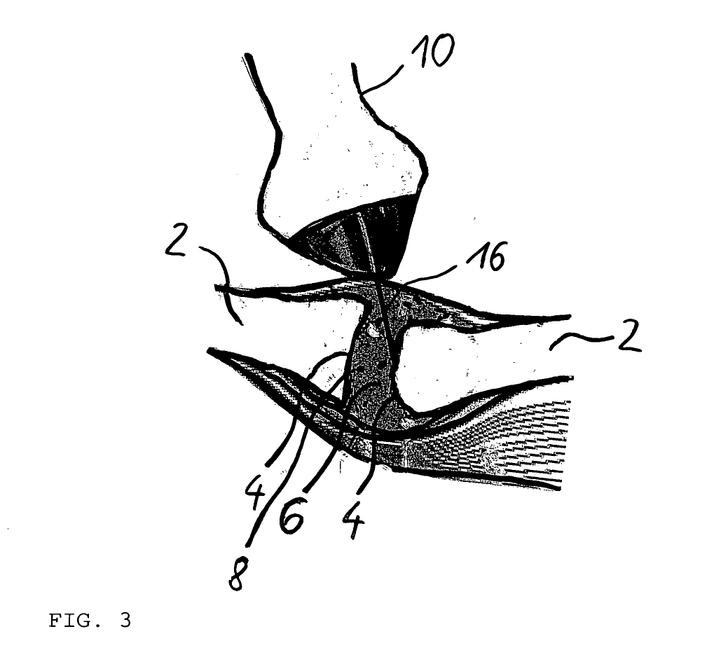

The novel method for treating of osteoarthritis in humans with shock waves described here and as is illustrated in FIG. 3 is to place the shock wave generation device 10 such that the shock waves coupled into an area between the bone spurs 4 down into and/or in a short distance to the cartilage.

In addition the novel method may utilize physical palpation, X-ray localization or ultrasound precisely to locate the site on which the shock waves have to be applied.

Applying the acoustic shock waves involves generating about 500 to about 4000 acoustic shock waves. The shock wave pulse frequency may be approximately 0.5-4 Hz (shock wave pulses/sec). Additionally, the number of treatments necessary for a positive response may vary from 1 to 4.

This novel method of application reduces the number of re-treatments and produces therapeutic healing of these conditions with minimal risk of complications or damage.

Furthermore, it has been observed to produce marked improvements in conditions which previously had no realistic hope of resolution, even with severe surgical measures with all the attendant risks. Surgery brings all the risk of anesthesia or sedation and the potential complication of any surgical procedure, including sepsis and continued morbidity.

The intentional method for treating osteoarthritis in humans bears far less risk to the patient than pharmacological and surgical intervention.

While the invention has been described in terms of various preferred embodiments, those of skill in the art will appreciate that various modifications, substitutions, omissions and changes may be made without departing from the spirit thereof. Accordingly, it is intended that the scope of the present invention not be limited solely by the scope of the claims. The invention is not only limited to shock wave applications but also to pressure wave applications.

What is claimed is:

1. A method for treating osteoarthritis in humans, the method comprising the steps of:
locating a site or suspected site of an abnormal condition of osteoarthritis;
generating acoustic pressure or shock waves;
introduction said acoustic pressure or shock waves on said located site;
and
applying a sufficient number of said acoustic pressure or shock waves to said located site to induce or accelerate healing.

2. The method of claim 1, wherein said osteoarthritis is a degenerative joint disease.

3. The method of claim 1, wherein said acoustic pressure or shock waves are applied to normalize the increased molecular activities within the joint, especially on the level of the synovial tissue, reduce its inflammation, and thereby stop and/or reverse the osteoarthritic process.

4. The method of claim 1, wherein said acoustic pressure or shock waves are focused acoustic pressure or shock waves.

5. The method of claim 1, wherein said acoustic pressure or shock waves are non focused acoustic pressure or shock waves.

6. The method of claim 1, wherein a acoustic pressure or shock wave generation device 10 is placed such that said pressure or shock waves are coupled into an area between bone spurs (4) down into and/or in a short distance to a cartilage.

7. The method of claim 1, wherein applying a sufficient number of said acoustic pressure or shock wave comprises applying about 500 to about 4000 of said acoustic pressure or shock waves per treatment.

8. The method of claim 1, wherein applying a sufficient number of said acoustic pressure or shock waves comprises applying said acoustic pressure or shock waves in a single treatment.

9. The method of claim 1, wherein applying a sufficient number of said acoustic pressure or shock wave comprises applying said acoustic pressure or shock waves in a multiple treatment.

10. The method of claim 1, wherein the preferential method of shock wave generation is a electro hydraulic method.

11. The method of claim 10, wherein said electro hydraulic shock wave generating comprises generating said acoustic shock waves by applying a voltage potential across a spar gap generator ranging from about 14 kV to about 28 kV to generate each shock wave

12. The method of claim 1, wherein the method of said shock wave generation is a piezoelectric method or a electromagnetic method.

13. The method of claim 1, wherein the method of said pressure wave generation is a pneumatic or ballistic method.
